(19) United States
(12) Patent Application Publication
(10) Pub. No.: US 2023/0360612 A1
(43) Pub. Date: Nov. 9, 2023

(54) IMAGE DISPLAY DEVICE

(71) Applicant: Panasonic Intellectual Property Management Co., Ltd., Osaka (JP)

(72) Inventor: Hiroyuki FURUYA, Osaka (JP)

(73) Assignee: Panasonic Intellectual Property Management Co., Ltd., Osaka (JP)

(21) Appl. No.: 18/222,847

(22) Filed: Jul. 17, 2023

Related U.S. Application Data
(63) Continuation of application No. PCT/JP2021/043299, filed on Nov. 25, 2021.

(30) Foreign Application Priority Data
Jan. 20, 2021 (JP) 2021-007316

(51) Int. Cl. G01B 11/16; B60K 35/00; G09G 3/34

(52) U.S. Cl. CPC G09G 3/3413; B60K 35/00; G01B 11/18; B60K 2370/1529; B60K 2370/29; B60K 2370/336; B60K 2370/52; G09G 2320/0233

(57) ABSTRACT

An image display device includes: an image generation part configured to generate display light having a predetermined contour shape on the basis of an image signal; a hologram light guide plate having a light guide path in which the display light taken from an incident region propagates to an emission region, and a hologram configured to apply a diffraction action to the display light in the light guide path; a strain sensor configured to detect strain of the hologram light guide plate; and an image control circuit configured to control the image generation part. The image control circuit sets the display light generated by the image generation part, on the basis of a detection result of the strain sensor such that deformation of a display image due to strain of the hologram light guide plate is suppressed.

### CROSS REFERENCE TO RELATED APPLICATION

This application is a continuation of International Application No. PCT/JP2021/043299 filed on Nov. 25, 2021, entitled “IMAGE DISPLAY DEVICE”, which claims priority under 35 U.S.C. Section 119 of Japanese Patent Application No. 2021-007316 filed on Jan. 20, 2021, entitled “IMAGE DISPLAY DEVICE”. The disclosures of the above applications are incorporated herein by reference.

### BACKGROUND OF THE INVENTION

### Field of the Invention

The present invention relates to an image display device that displays an image and that is, for example, suitable to be mounted on a moving body such as a passenger car.

### Description of Related Art

In recent years, an image display device referred to as a head-up display has been developed and mounted on a moving body such as a passenger car. In a head-up display mounted on a passenger car, light modulated by image information is projected toward a windshield, and reflected light thereof is applied to the eyes of a driver. Accordingly, the driver is allowed to see a virtual image as an image in front of the windshield. For example, drive assist information, such as a vehicle speed, various warning markers, and an arrow indicating the travelling direction of the passenger car, is displayed as a virtual image.

Japanese Laid-Open Patent Publication No. 2011-90076 describes an image display device including: a modulation element that modulates light emitted from a laser light source to form an image; and a hologram element that reflects the light emitted from the modulation element. The light reflected by the hologram element is guided to the vicinity of the eyes of a driver.

In the above configuration, strain may occur in the hologram element due to heat, deformation of a dashboard, or the like. Such strain of the hologram element may cause strain in the light emitted from the hologram element, resulting in deformation of a display image.

### SUMMARY OF THE INVENTION

An image display device according to a main aspect of the present invention includes: an image generation part configured to generate display light having a predetermined contour shape on the basis of an image signal; a hologram light guide plate having a light guide path in which the display light taken from an incident region propagates to an emission region, and a hologram configured to apply a diffraction action to the display light in the light guide path; a strain sensor configured to detect strain of the hologram light guide plate; and a controller configured to control the image generation part. The controller sets the display light generated by the image generation part, on the basis of a detection result of the strain sensor such that deformation of a display image due to strain of the hologram light guide plate is suppressed.

In the image display device according to this aspect, the display light generated by the image generation part is set on the basis of a detection result corresponding to strain of the hologram light guide plate such that deformation of the display image is suppressed. Accordingly, even if strain occurs in the hologram light guide plate, the display light generated by the image generation part is set as described above, thereby suppressing deformation of the display light emitted from the hologram light guide plate, so that deformation of the display image can be suppressed.

The effects and the significance of the present invention will be further clarified by the description of the embodiment below. However, the embodiment below is merely an example for implementing the present invention. The present invention is not limited to the description of the embodiment below in any way.

### BRIEF DESCRIPTION OF THE DRAWINGS

FIG. 1A and FIG. 1B are diagrams schematically showing a use form of an image display device according to an embodiment;

FIG. 1C is a diagram schematically showing a configuration of the image display device according to the embodiment;

FIG. 2 is a diagram schematically showing a configuration of an image generation part of the image display device according to the embodiment and configurations of circuits used for the image generation part;

FIG. 3A is a plan view schematically showing configurations of a hologram light guide plate and strain sensors according to the embodiment;

FIG. 3B is a perspective view schematically showing the configurations of the hologram light guide plate and the strain sensors according to the embodiment;

FIG. 4A is a side view when viewing the hologram light guide plate according to the embodiment in a rear direction;

FIG. 4B is a side view when viewing the hologram light guide plate according to the embodiment in a left direction;

FIG. 5A and FIG. 5B are each a side view schematically showing a state where the hologram light guide plate according to the embodiment is strained at the position of a hologram;

FIG. 6A, FIG. 6B, and FIG. 6C are each a diagram schematically showing display light and an image according to the embodiment;

FIG. 7A, FIG. 7B, and FIG. 7C are diagrams schematically showing a deformation correction table, a luminance correction table, and a power correction table according to the embodiment, respectively;

FIG. 8A is a plan view schematically showing configurations of a hologram light guide plate and strain sensors according to Modification 1 of the placement of the strain sensors; and

FIG. 8B is a plan view schematically showing configurations of a hologram light guide plate and strain sensors according to Modification 2 of the placement of the strain sensors.

It should be noted that the drawings are solely for description and do not limit the scope of the present invention by any degree.

### DETAILED DESCRIPTION

Hereinafter, an embodiment of the present invention will be described with reference to the drawings. For convenience, in each drawing, X, Y, and Z axes that are orthogonal to each other are additionally shown as appropriate.

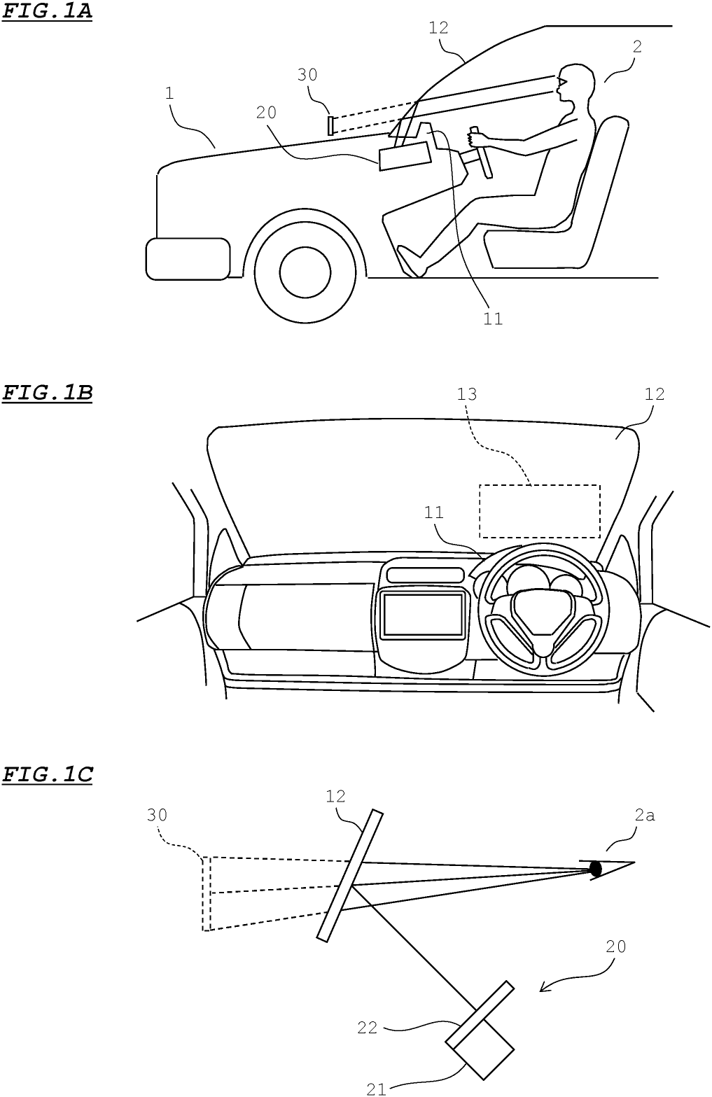

FIG. 1A and FIG. 1B are diagrams schematically showing a use form of an image display device 20. FIG. 1A is a schematic diagram in which the inside of a passenger car 1 is seen through from a lateral side of the passenger car 1, and FIG. 1B is a diagram when the front in a travelling direction is viewed from the inside of the passenger car 1.

In the present embodiment, the present invention is applied to a vehicle-mounted head-up display. As shown in FIG. 1A, the image display device 20 is installed within a dashboard 11 of the passenger car 1.

As shown in FIG. 1A and FIG. 1B, the image display device 20 projects display light modulated by an image signal onto a projection region 13 that is on a lower side of a windshield 12 and near a driver’s seat. The projected display light is reflected by the projection region 13 and applied to a horizontally long region (eye box region) around the positions of the eyes of a driver 2. Accordingly, a predetermined image 30 is displayed as a virtual image in the front field of view of the driver 2. The driver 2 is allowed to see the image 30, which is a virtual image, such that the image 30 is superimposed on a view in front of the windshield 12. That is, the image display device 20 forms the image 30, which is a virtual image, in a space in front of the projection region 13 of the windshield 12.

FIG. 1C is a diagram schematically showing a configuration of the image display device 20.

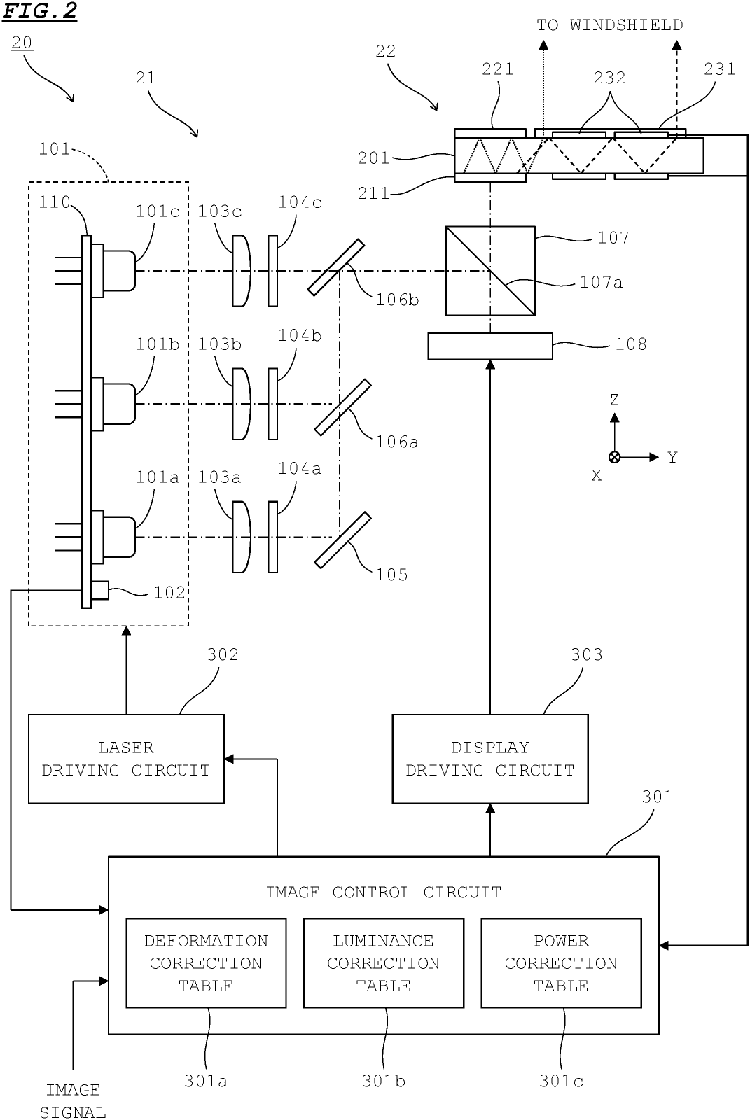

The image display device 20 includes an image generation part 21 and a hologram light guide plate 22. The image generation part 21 generates display light modulated by the image signal and having a predetermined contour shape and predetermined luminance, and emits the generated display light. The hologram light guide plate 22 has holograms 211, 221, and 231 (see FIG. 2), causes the display light emitted from the image generation part 21 to propagate therethrough, and guides the display light to the projection region 13 of the windshield 12. The display light reflected by the windshield 12 is applied to eyes 2a of the driver 2. An optical system of the image generation part 21 and the hologram light guide plate 22 are designed such that the image 30, which is a virtual image, is displayed in front of the windshield 12 in a predetermined size.

FIG. 2 is a diagram schematically showing a configuration of the image generation part 21 of the image display device 20 and configurations of circuits used for the image generation part 21.

The image generation part 21 includes a light source 101, a temperature sensor 102, collimator lenses 103a to 103c, apertures 104a to 104c, a mirror 105, dichroic mirrors 106a and 106b, a polarizing beam splitter 107, and a spatial light modulator 108.

The light source 101 includes three laser light sources 101a, 101b, and 101c.

The laser light source 101a emits laser light having a red wavelength included in the range of 635 nm or more and 645 nm or less, the laser light source 101b emits laser light having a green wavelength included in the range of 510 nm or more and 530 nm or less, and the laser light source 101c emits laser light having a blue wavelength included in the range of 440 nm or more and 460 nm or less.

In the present embodiment, in order to display a color image as the image 30, the light source 101 includes these three laser light sources 101a, 101b, and 101c. The laser light sources 101a, 101b, and 101c are each composed of, for example, a semiconductor laser. In the case of displaying a single-color image as the image 30, the light source 101 may include only one laser light source corresponding to the color of the image. In addition, the light source 101 may include two laser light sources having different emission wavelengths.

The laser light sources 101a, 101b, and 101c are installed on one circuit board 110, and the temperature sensor 102 for detecting temperature (ambient temperature) near the installation location of the laser light sources 101a, 101b, and 101c is installed on the circuit board 110. The temperature sensor 102 is installed in the vicinity of the laser light source 101a which emits the laser light having a red wavelength. That is, the temperature sensor 102 is placed at a position closer to the laser light source 101a than to the other laser light sources 101b and 101c. A temperature sensor may be placed for each of the laser light sources 101a, 101b, and 101c.

The laser lights emitted from the laser light sources 101a, 101b, and 101c is converted to collimated lights by the collimator lenses 103a to 103c, respectively. The laser lights that have passed through the collimator lenses 103a to 103c are shaped into beams each having a shape (rectangular shape) that is the shape of a modulation region of the spatial light modulator 108, by the apertures 104a to 104c, respectively. That is, the apertures 104a to 104c form a beam shaping part for matching the beam sizes and the beam shapes of the laser lights emitted from the laser light sources 101a, 101b, and 101c, respectively, with each other.

Instead of the collimator lenses 103a to 103c, shaping lenses for shaping the laser lights into beams each having a shape that is the shape of the modulation region of the spatial light modulator 108 and converting the laser lights to collimated lights may be used. In this case, the apertures 104a to 104c can be omitted.

Thereafter, the optical axes of the laser lights of the respective colors emitted from the laser light sources 101a, 101b, and 101c are caused to coincide with each other by the mirror 105 and the two dichroic mirrors 106a and 106b. The mirror 105 substantially totally reflects the red laser light that has passed through the collimator lens 103a. The dichroic mirror 106a reflects the green laser light that has passed through the collimator lens 103b, and transmits the red laser light reflected by the mirror 105. The dichroic mirror 106b transmits the blue laser light that has passed through the collimator lens 103c, and reflects the red laser light and the green laser light that have passed through the dichroic mirror 106a. The mirror 105 and the two dichroic mirrors 106a and 106b are placed such that the optical axes of the laser lights of the respective colors emitted from the laser light sources 101a, 101b, and 101c are caused to coincide with each other.

The laser light sources 101a, 101b, and 101c are placed such that the laser light of each color incident on the polarizing beam splitter 107 is S-polarized.

The polarizing beam splitter 107 includes a polarizing surface 107a which reflects S-polarized light and allows P-polarized light to pass therethrough. The laser light of each color that has passed through the dichroic mirror 106b is reflected by the polarizing surface 107a of the polarizing beam splitter 107 and guided to the spatial light modulator 108.

The spatial light modulator 108 is composed of, for example, LCOS (Liquid Crystal On Silicon). The spatial light modulator 108 modulates the light of each color reflected by the polarizing surface 107a, according to a driving signal, and generates display light that is the source of the image 30. At this time, a rotation angle in a polarization direction of the laser light of each color is adjusted for each pixel to an angle corresponding to the luminance of the pixel. Accordingly, as for the laser light of each color from the spatial light modulator 108 toward the polarizing beam splitter 107, the amount of the laser light passing through the polarizing surface 107a is adjusted for each pixel. Thus, display light corresponding to a rendered image is generated by the laser light of each color passing through the polarizing surface 107a.

The hologram light guide plate 22 includes a light guide path 201 and the holograms 211, 221, and 231.

The light guide path 201 is composed of a transparent flat glass plate. The light guide path 201 may be composed of a transparent flat resin plate instead of a glass plate. The holograms 211, 221, and 231 apply a diffraction action to the display light in the light guide path 201. The holograms 211, 221, and 231 cause the display light travelling in the Z-axis positive direction via the polarizing beam splitter 107 to propagate in the light guide path 201 and also diffuse the display light in the X-Y plane to guide the display light to the projection region 13 of the windshield 12 (see FIG. 1B).

A diffraction pattern formed in the hologram 231 has a lens effect. Due to the lens effect of the diffraction pattern of the hologram 231, the display light emitted from the hologram light guide plate 22 is guided to the projection region 13 at a predetermined spread angle to form the image 30 having a predetermined size in front of the windshield 12. Instead of the lens effect being imparted to the diffraction pattern of the hologram 231, a lens may be provided between the hologram light guide plate 22 and the windshield 12.

Strain sensors 232 are installed on the surface of the light guide path 201 in the vicinity of the hologram 231. The strain sensors 232 detect strain of the hologram light guide plate 22. The strain sensors 232 are each a sensor that outputs, as a detection signal, a resistance value that changes as the sensor expands and contracts. As described later, the detection signals of the strain sensors 232 are used for correcting deformation of the image 30 due to strain of the hologram 231.

An image control circuit 301 includes an arithmetic processing unit such as a CPU, and a memory. The image control circuit 301 processes an inputted image signal and controls a laser driving circuit 302 and a display driving circuit 303. In addition, the image control circuit 301 includes a deformation correction table 301a, a luminance correction table 301b, and a power correction table 301c in the memory.

As described later, on the basis of the detection results of the strain sensors 232, the image control circuit 301 controls the spatial light modulator 108 via the display driving circuit 303 and sets the display light generated by the image generation part 21 (spatial light modulator 108) such that deformation of the image 30 due to strain of the hologram light guide plate 22 is suppressed. On the basis of the detection results of the strain sensors 232, the image control circuit 301 also controls the spatial light modulator 108 via the display driving circuit 303 and sets the luminance of the display light generated by the image generation part 21 (spatial light modulator 108) such that luminance unevenness of the image 30 is suppressed. On the basis of the detection results of the temperature sensors 102, the image control circuit 301 further controls the emission power of the light source 101 via the laser driving circuit 302 and sets the brightness of the display light generated by the image generation part 21 (spatial light modulator 108) such that a decrease in the luminance of the image 30 (see FIG. 1C) is suppressed.

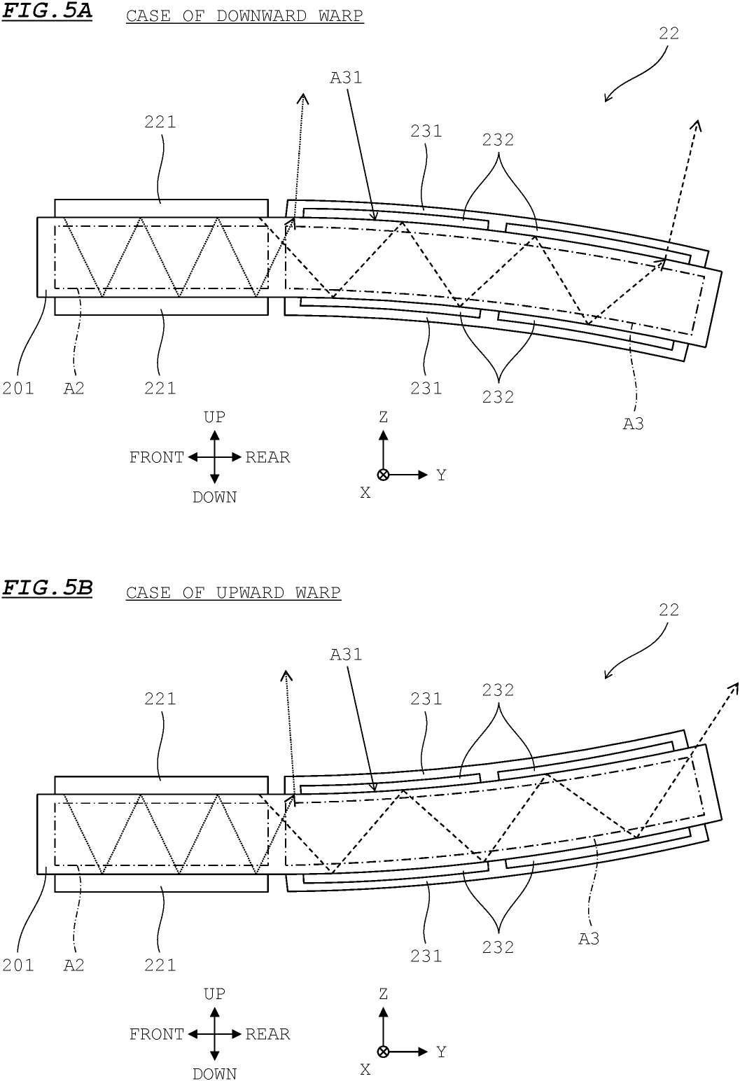

The image control circuit 301 refers to the deformation correction table 301a, the luminance correction table 301b, and the power correction table 301c when performing these controls. These controls will be described with reference to FIG. 5A to FIG. 7C later.

The laser driving circuit 302 drives the laser light sources 101a, 101b, and 101c according to control signals inputted from the image control circuit 301. The display driving circuit 303 drives the spatial light modulator 108 according to a control signal inputted from the image control circuit 301.

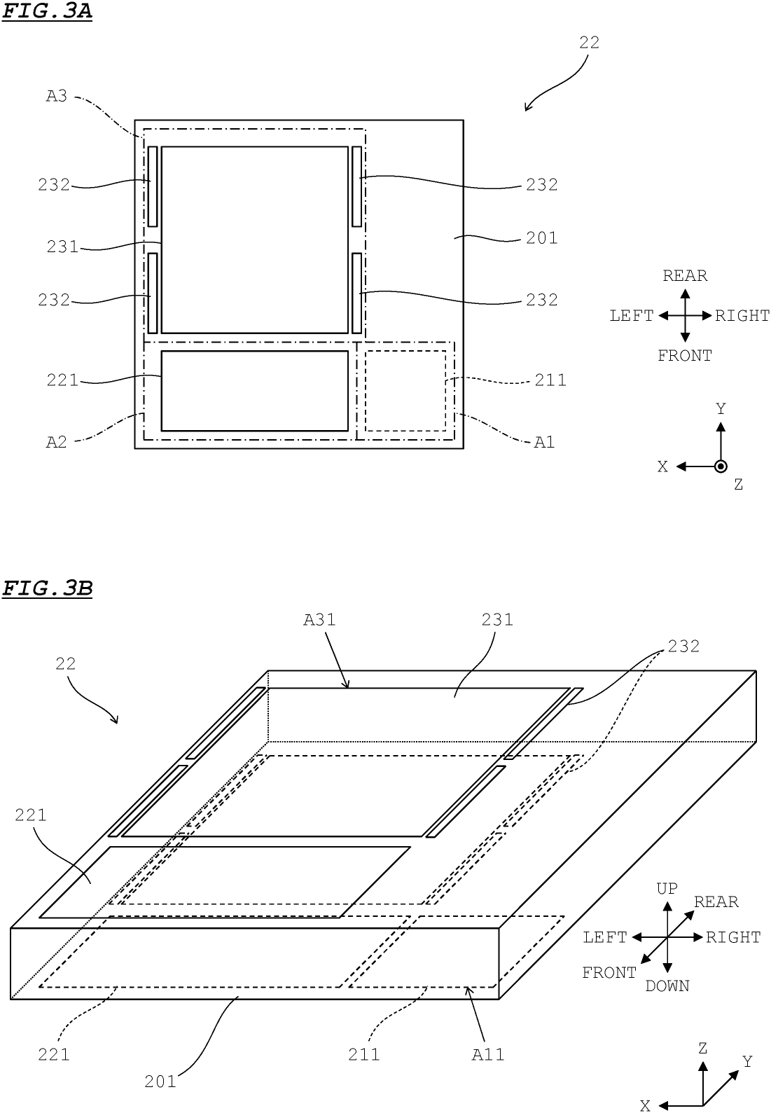

FIG. 3A is a plan view schematically showing configurations of the hologram light guide plate 22 and the strain sensors 232 as viewed in the Z-axis negative direction. FIG. 3B is a perspective view schematically showing the configurations of the hologram light guide plate 22 and the strain sensors 232. In FIG. 3A and FIG. 3B, for convenience, the right-left direction, the front-rear direction, and the up-down direction correspond to the respective directions of the X, Y, and Z axes.

As shown in FIG. 3A and FIG. 3B, one hologram 211, two holograms 221, and one hologram 231 are installed at the light guide path 201. The hologram 211 is installed on the lower surface at the front end and the right end of the light guide path 201. The holograms 221 are installed on the upper surface and the lower surface at the front end and the left end of the light guide path 201. The two holograms 221 are installed at the same position in a plan view. The hologram 231 is installed on the upper surface at the rear end and the left end of the light guide path 201. The holograms 211 and 231 each have a substantially square shape, and each hologram 221 has a rectangular shape having a width in a short side direction thereof substantially equal to that of the hologram 211 and having a width in a long side direction thereof substantially equal to that of the hologram 231.

As shown in FIG. 3A, a region of the light guide path 201 located at the same position as the hologram 211 in a plan view is referred to as spatial region A1, a region of the light guide path 201 located at the same position as the holograms 221 in a plan view is referred to as spatial region A2, and a region of the light guide path 201 located at the same position as the hologram 231 in a plan view is referred to as spatial region A3.

The display light emitted from the image generation part 21 is taken into the light guide path 201 from an incident region A11 located at the lower surface of the spatial region A1. The display light taken from the incident region A11 is caused to propagate and diffuse in the spatial regions A1, A2, and A3 in this order, and is emitted upward from an emission region A31 located at the upper surface of the spatial region A3.

Four strain sensors 232 are installed on the upper surface of the light guide path 201, and four strain sensors 232 are installed on the lower surface of the light guide path 201. Of the four strain sensors 232 on the upper surface side, two strain sensors 232 are placed on each of the left side and the right side of the hologram 231. The four strain sensors 232 on the upper surface side and the four strain sensors 232 on the lower surface side are installed at the same positions in a plan view.

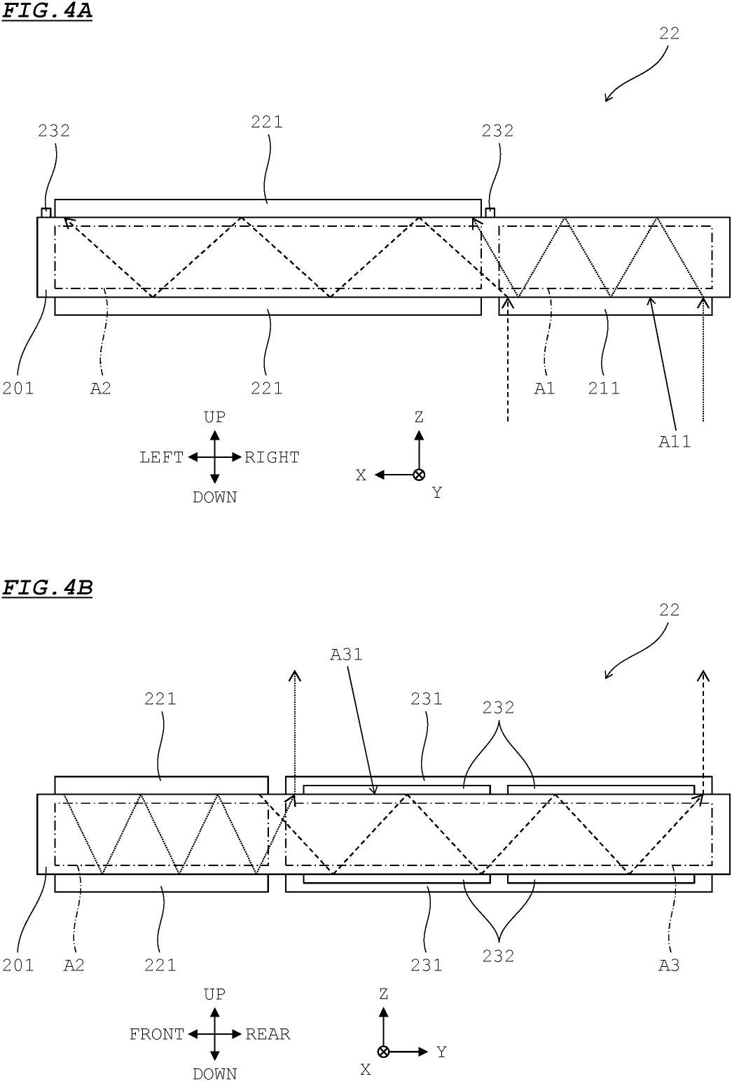

FIG. 4A is a side view when viewing the hologram light guide plate 22 in the Y-axis positive direction (rear direction). FIG. 4B is a side view when viewing the hologram light guide plate 22 in the X-axis positive direction (left direction).

The hologram light guide plate 22 causes the display light applied to the entirety of the incident region A11 to propagate along the light guide path 201 by the diffraction actions by the holograms 211 and 221 such that the display light spreads over the entirety of the emission region A31. The luminance distribution of the display light in the incident region A11 is a luminance distribution modulated by the spatial light modulator 108. As the luminance distribution of the display light in the emission region A31, the luminance distribution of the display light in the incident region A11 is reflected as it is. That is, the hologram light guide plate 22 applies a diffraction action to the display light by the holograms 211 and 221 such that the luminance distribution of the display light in the incident region A11 is projected to the entirety of the emission region A31. Thus, the display light spreading over the entirety of the emission region A31 is diffracted by the hologram 231 in the emission region A31 and emitted upward. At this time, together with the refraction action by the windshield 12 (see FIG. 1A), the hologram 231 applies a diffraction action (lens action) to the display light such that an image rendered by the spatial light modulator 108 is projected as a virtual image in the image 30.

As shown in FIG. 4A, the hologram 211 diffracts the display light to take the display light into the incident region A11. The hologram 211 is configured such that a diffraction angle at which the display light is diffracted increases from the right end toward the left end thereof. The display light incident from the right end of the incident region A11 travels in the left direction while being totally reflected in the light guide path 201 at the spatial region A1, and reaches the spatial region A2. Meanwhile, the display light incident from the left end of the incident region A11 reaches the spatial region A2 as it is without being reflected in the light guide path 201 at the spatial region A1.

Thus, the display light reaching the spatial region A2 travels toward the spatial region A3 while being reflected in the light guide path 201 at the spatial region A2 with the travelling direction thereof being bent in the Y-axis positive direction by the holograms 221 at the spatial region A2. Accordingly, the display light is guided to the emission region A31 at the spatial region A3 and reaches the hologram 231 which is placed at the emission region A31.

As shown in FIG. 4B, the hologram 231 diffracts the display light reaching the emission region A31, and guides the display light to above the hologram light guide plate 22. The hologram 231 is configured such that an incident angle at which the diffraction action can be exhibited (hereinafter, referred to as “effective incident angle”) increases toward the rear end thereof. Therefore, a light beam shown by a broken line arrow in FIG. 4B has a large incident angle with respect to the hologram 231, thus does not undergo a diffraction action in a front-side region of the hologram 231, is repeatedly totally reflected in the light guide path 201 at the spatial region A3, and reaches the rear end of the hologram 231. The incident angle of the light beam matches the effective incident angle at the rear end of the hologram 231. Therefore, the light beam undergoes a diffraction action at the rear end of the hologram 231 and is emitted upward. On the other hand, a light beam shown by a dotted line in FIG. 4B has a small incident angle with respect to the hologram 231. The incident angle of the light beam matches the effective incident angle at the front end of the hologram 231. Therefore, the light beam undergoes a diffraction action at the front end of the hologram 231 and is emitted upward.

The distribution in the front-rear direction of the effective incident angle of the hologram 231 corresponds to the distribution in the right-left direction of the diffraction angle of the hologram 211 which is placed in the incident region A11. Therefore, the display light taken into the incident region A11 passes through the hologram 231, which is placed at the emission region A31, in a state where the region of the display light is expanded to the size of the emission region A31, and the display light is emitted upward from the emission region A31. At this time, together with the refraction action by the windshield 12 (see FIG. 1A), the hologram 231 applies a diffraction action (lens action) to the display light such that the image rendered by the spatial light modulator 108 is projected as a virtual image in the image 30. Thus, the image 30 is displayed by the display light projected to the projection region 13 of the windshield 12.

Here, the hologram light guide plate 22 may be strained due to an increase in the temperature of the dashboard 11, in which the image display device 20 is installed, deformation of the dashboard 11 itself, etc. In such a case, the display light emitted from the hologram light guide plate 22 is deformed from a normal shape, so that the image 30 (see FIG. 1C) which is a virtual image is also deformed.

FIG. 5A and FIG. 5B are each a side view schematically showing a state where the hologram light guide plate 22 is strained at the position of the hologram 231. FIG. 5A shows a state where the hologram light guide plate 22 is bent downward, that is, an “downward warp” state, and FIG. 5B shows a state where the hologram light guide plate 22 is bent upward, that is, an “upward warp” state.

In the case of FIG. 5A, the display light of a broken line arrow reaching the rear end of the spatial region A2 is incident on the hologram 231 at a slightly frontward position than that in the case shown in FIG. 4B, due to the strain of the hologram light guide plate 22. Therefore, the display light passes through the hologram 231 at a position slightly frontward of the rear end of the emission region A31. Accordingly, the width in the front-rear direction of the display light emitted from the hologram light guide plate 22 is narrower than that in the case of FIG. 4B.

Meanwhile, in the case of FIG. 5B, the display light of a broken line arrow reaching the rear end of the spatial region A2 is incident on the hologram 231 at a slightly rearward position than that in the case shown in FIG. 4B, due to the strain of the hologram light guide plate 22. Therefore, the display light is emitted to the outside of the light guide path 201 from a position slightly rearward of the rear end of the emission region A31. Accordingly, the width in the front-rear direction of the display light emitted from the hologram light guide plate 22 is wider than that in the case of FIG. 4B.

As described above, when strain occurs in the hologram light guide plate 22 at the position of the hologram 231, the width in the front-rear direction of the display light emitted from the hologram light guide plate 22 changes. In addition, due to the displacement of the display light relative to the hologram 231, the diffraction action of the hologram 231 is not properly applied to the display light, so that the shape of the display light emitted from the hologram light guide plate 22 changes from the normal shape not only in the front-rear direction but also in the right-left direction.

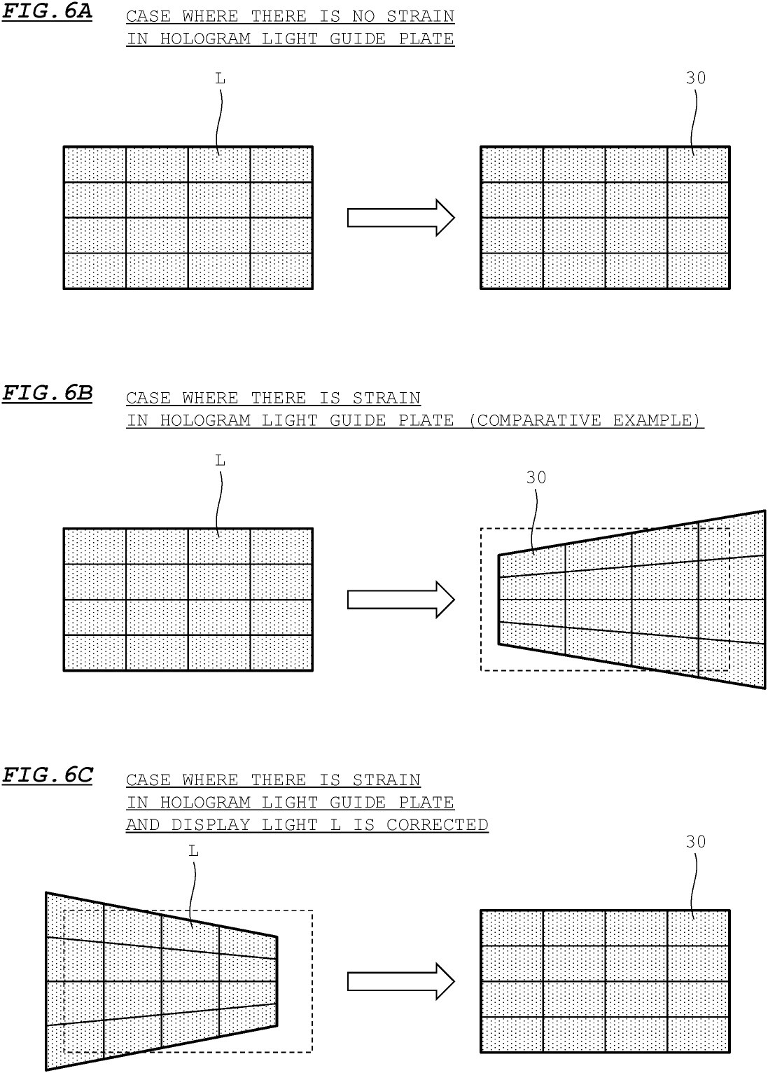

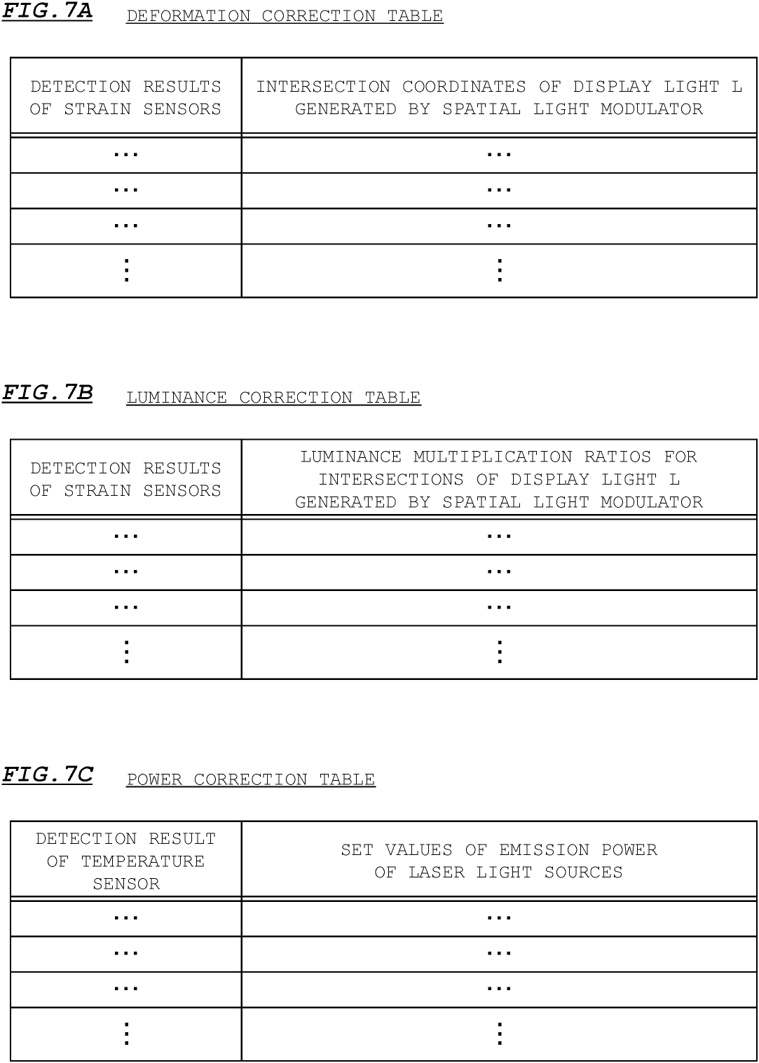

In this regard, in the present embodiment, strain of the hologram light guide plate 22 is detected by the strain sensors 232, and the display light generated by the image generation part 21 is set on the basis of the detection results of the strain sensors 232 such that deformation of the image 30 is suppressed. Hereinafter, this control will be described with reference to FIG. 6A to FIG. 7A.

FIG. 6A to FIG. 6C are each a diagram schematically showing display light L and the image 30. Hereafter, for convenience, the light generated by the spatial light modulator 108 and travelling toward the polarizing beam splitter 107 is referred to as display light L.

FIG. 6A shows the display light L and the image 30 in the case where there is no strain in the hologram light guide plate 22. FIG. 6B shows the display light L and the image 30 in the case where there is strain in the hologram light guide plate 22 at the position of the hologram 231 (comparative example). FIG. 6C shows the display light L and the image 30 in the case where there is strain in the hologram light guide plate 22 at the position of the hologram 231 and the display light L is corrected. In FIG. 6A to FIG. 6C, for convenience, the display light L and the image 30 are each divided into 16 regions by gridded division lines.

As shown in FIG. 6A, the contour shape of the display light L generated by the spatial light modulator 108 is normally rectangular. When there is no strain in the hologram light guide plate 22, the image 30 formed by the rectangular display light L also properly becomes rectangular. In this case, there is no need to set (correct) the display light L.

As shown in FIG. 6B, when there is strain in the hologram light guide plate 22 at the position of the hologram 231, the display light emitted from the hologram light guide plate 22 on the basis of the rectangular display light L is deformed, and the image 30 is also unintentionally made into a deformed shape. In this case, the deformation of the image 30 can be eliminated by correcting the display light L as shown in FIG. 6C.

The setting (correction) of the display light L will be described with reference to FIG. 6C.

When there is strain in the hologram light guide plate 22 at the position of the hologram 231, the image control circuit 301 (see FIG. 2) refers to the deformation correction table 301a and acquires intersection coordinates of the display light L after correction on the basis of the detection results of the strain sensors 232. The shape of the image 30 is corrected by scaling up or down the 16 regions divided in a grid pattern on the basis of the intersection coordinates.

FIG. 7A is a diagram schematically showing a configuration of the deformation correction table 301a.

In the deformation correction table 301a, intersection coordinates of the display light L for suppressing deformation of the image 30 are stored in advance in association with the detection results of the strain sensors 232. The detection results of the strain sensors 232 are values, indicating how much the hologram light guide plate 22 is strained, from the detection signals of the eight strain sensors 232 which are installed around the hologram 231. The intersection coordinates in the deformation correction table 301a are the coordinates of 25 intersections of the gridded division lines in the display light L after deformation (correction) in FIG. 6C.

Returning to FIG. 6C, the image control circuit 301 refers to the deformation correction table 301a and acquires the 25 intersection coordinates of the display light L after correction on the basis of the detection results of the strain sensors 232. Then, the image control circuit 301 controls the spatial light modulator 108 via the display driving circuit 303 such that the intersection coordinates of the display light L generated by the spatial light modulator 108 become the acquired 25 intersection coordinates. At this time, the 16 regions of the display light L divided in a grid pattern on the basis of the intersection coordinates are scaled up or down according to the acquired 25 intersection coordinates. Accordingly, as shown in FIG. 6C, the image 30 is corrected and made into an appropriate rectangular shape.

When the hologram light guide plate 22 is strained, luminance variation (luminance unevenness) also occurs at each position of the image 30. For example, in the case of FIG. 5B, the display light of the broken line arrow is not diffracted and leaks to the outside, so that the rear end side of the image 30 tends to be dark. In this regard, in the present embodiment, on the basis of the detection results of the strain sensors 232, the image control circuit 301 refers to the luminance correction table 301b and sets a luminance value of the display light L generated by the spatial light modulator 108.

FIG. 7B is a diagram schematically showing a configuration of the luminance correction table 301b.

In the luminance correction table 301b, luminance multiplication ratios for the intersections of the display light L for suppressing luminance unevenness of the image 30 are stored in advance in association with the detection results of the strain sensors 232. The luminance multiplication ratios in the luminance correction table 301b are luminance multiplication ratios for the 25 intersections when the display light L is divided by the gridded division lines.

The image control circuit 301 refers to the luminance correction table 301b and acquires the luminance multiplication ratios for the 25 intersections of the display light L on the basis of the detection results of the strain sensors 232. Then, the image control circuit 301 controls the spatial light modulator 108 via the display driving circuit 303 such that the luminance values at the intersections of the display light L generated by the spatial light modulator 108 become values obtained by multiplying the luminance values of the display light L before correction by the luminance multiplication ratios. Accordingly, the luminance unevenness of the image 30 is corrected and the luminance of the image 30 is made appropriate.

When the temperature of the light source 101 changes, the wavelength of the laser light of each color emitted from the light source 101 changes from the desired wavelength. In this case, the wavelength of the display light L generated by the spatial light modulator 108 also changes, and thus the diffraction efficiency of the holograms 211, 221, and 231 changes. Accordingly, the brightness of the entire image 30 varies in response to the temperature. In this regard, in the present embodiment, the temperature of the light source 101 is detected by the temperature sensor 102, and the image control circuit 301 refers to the power correction table 301c and sets the emission power of the laser light sources 101a to 101c on the basis of the detection result of the temperature sensor 102.

FIG. 7C is a diagram schematically showing a configuration of the power correction table 301c.

In the power correction table 301c, set values of the emission power of the laser light sources 101a to 101c are stored in advance in association with the detection result of the temperature sensor 102. The image control circuit 301 refers to the power correction table 301c and acquires the set values of the emission power of the laser light sources 101a to 101c on the basis of the detection result of the temperature sensor 102. Then, the image control circuit 301 controls the laser light sources 101a to 101c via the laser driving circuit 302 such that the laser light sources 101a to 101c emit light at the respective acquired set values. Accordingly, the brightness of the image 30 is corrected and the luminance of the image 30 is made appropriate.

In the power correction table 301c, multiplication ratios for uniformly changing the gradations of all pixels in the spatial light modulator 108 (overall gradation of the image 30) may be stored in advance in association with the detection result of the temperature sensor 102. In this case, the image control circuit 301 controls the spatial light modulator 108 via the display driving circuit 303 such that the gradations of all pixels of the display light L generated by the spatial light modulator 108 become values obtained by multiplying the gradations of all the pixels of the display light L before correction by the multiplication ratios.

### Effects of Embodiment

According to the present embodiment, the following effects are achieved.

The image control circuit 301 (controller) sets the display light L generated by the image generation part 21, on the basis of the detection results of the strain sensors 232 such that deformation of the image 30 (display image) due to strain of the hologram light guide plate 22 is suppressed. Accordingly, even if strain occurs in the hologram light guide plate 22, the contour shape of the display light L generated by the image generation part 21 is set and each region of the display light L is scaled up or down as shown on the left side of FIG. 6C, thereby suppressing deformation of the display light L emitted from the hologram light guide plate 22, so that deformation of the image 30 can be suppressed as shown on the right side of FIG. 6C.

The strain sensors 232 are placed in the vicinity of the placement region of the hologram 231 along the propagation direction of the display light (Y-axis direction). If strain occurs at the position of the hologram 231 in the propagation direction of the display light in the spatial region A3, a diffraction action is not properly applied to the display light incident on the hologram 231, and as a result, the display light emitted from the hologram light guide plate 22 is likely to be significantly deformed. In this regard, when the strain sensors 232 are placed in the vicinity of the placement region of the hologram 231 along the propagation direction of the display light (Y-axis direction), strain at the position of the hologram 231 in the propagation direction can be accurately detected, and thus the deformation state of the image 30 can be accurately grasped. Therefore, the image 30 can be more appropriately corrected by the image control circuit 301.

The strain sensors 232 are placed at the same positions on the upper surface and the lower surface of the hologram light guide plate 22 in a plan view. When the strain sensors 232 are placed on the upper surface and the lower surface of the hologram light guide plate 22 in a paired manner as described above, strain of the hologram light guide plate 22 can be accurately detected. Accordingly, deformation of the display light L can be accurately corrected.

The two strain sensors 232 are placed along one side of the hologram 231. When the two strain sensors 232 are placed along one side of the hologram 231 as described above, strain of the hologram light guide plate 22 can be detected more accurately than in the case where one strain sensor 232 is placed along one side of the hologram 231. Accordingly, deformation of the display light L can be more accurately corrected.

The image control circuit 301 (controller) sets the luminance of the display light L generated by the image generation part 21, on the basis of the detection results of the strain sensors 232 such that luminance unevenness of the image 30 (display image) due to strain of the hologram light guide plate 22 is suppressed. If strain occurs in the hologram light guide plate 22, luminance unevenness occurs in the image 30 based on the display light emitted from the hologram light guide plate 22. In this regard, the image control circuit 301 controls the image generation part 21 on the basis of the strain of the hologram light guide plate 22 such that the luminance unevenness of the image 30 is suppressed. Accordingly, occurrence of luminance unevenness in the image 30 based on the display light emitted from the hologram light guide plate 22 can be suppressed.

The hologram 231 is placed at the emission region A31, and the strain sensor 232 is placed near the emission region A31. The hologram 231 which is located at the emission region A31 is the most likely to affect deformation of the display light emitted from the hologram light guide plate 22. Therefore, deformation of the image 30 can be more effectively suppressed by detecting deformation of the hologram 231 at the emission region A31 with the strain sensors 232 and controlling the image generation part 21.

### Modifications

In the above embodiment, the strain sensors 232 are placed in the vicinity of the placement region of the hologram 231 along the propagation direction of the display light (Y-axis direction). However, a hologram may be further placed at another position.

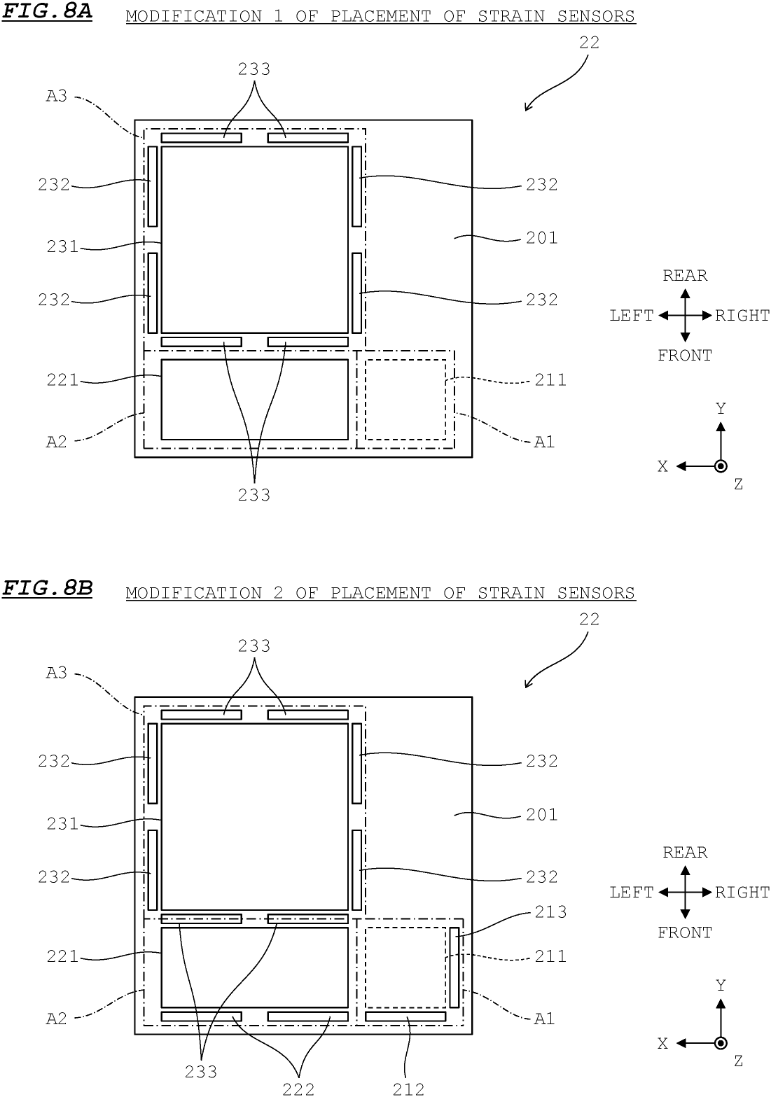

FIG. 8A is a plan view schematically showing configurations of the hologram light guide plate 22 and strain sensors 232 and 233 according to Modification 1 of the placement of the strain sensors.

In this modification, the strain sensors 233 are placed in the vicinity of the placement region of the hologram 231 along a direction (X-axis direction) perpendicular to the propagation direction of the display light in the spatial region A3 (Y-axis direction). In addition, the strain sensors 233 are placed at the same positions on the upper surface and the lower surface of the hologram light guide plate 22 in a plan view, and two strain sensors 233 are placed along one side of the hologram 231.

In this modification, the strain sensors 232 and 233 are placed along adjacent two sides of the hologram 231, respectively. Accordingly, strain of the hologram 231 can be detected in directions (X-axis direction and Y-axis direction) respectively parallel to the adjacent two sides of the placement region of the hologram 231. Therefore, deformation of the display light in the directions respectively parallel to the two sides can be suppressed.

However, the display light emitted from the hologram light guide plate 22 is more likely to be significantly deformed when strain occurs in the hologram 231 in the propagation direction of the display light in the spatial region A3 than when strain occurs in the hologram 231 in the direction perpendicular to the propagation direction of the display light in the spatial region A3. Therefore, it can be said that deformation of the image 30 can be effectively suppressed even if only the strain sensors 232 are provided as in the above embodiment. In addition, from such a viewpoint, only one strain sensor 233 may be placed at one side of the hologram 231.

FIG. 8B is a plan view schematically showing configurations of the hologram light guide plate 22 and strain sensors 212, 213, 222, 232, and 233 according to Modification 2 of the placement of the strain sensors.

In this modification, the strain sensors 212 and 213 are placed in the vicinity of the placement region of the hologram 211. The strain sensors 212 and 213 are placed along the propagation direction of the display light in the spatial region A1 (X-axis direction) and a direction (Y-axis direction) perpendicular to the propagation direction, respectively. In addition, the strain sensors 222 and 233 are placed in the vicinity of the placement region of the hologram 221. The strain sensors 222 and 233 are placed along the long side direction of the hologram 221 (X-axis direction). The strain sensors 212, 213, 222, and 233 are placed at the same positions on the upper surface and the lower surface of the hologram light guide plate 22 in a plan view, and two strain sensors 222 are placed along one side of the hologram 221.

In this modification, the strain sensors 212 and 213 are placed along adjacent two sides of the hologram 211, respectively. Accordingly, deformation of the display light in directions parallel to the two sides of the hologram 211 can be grasped, and can be accurately corrected. In addition, the strain sensor 212 is placed along the propagation direction of the display light in the spatial region A1, and thus can accurately detect strain of the hologram light guide plate 22 in a direction (X-axis direction) in which deformation of the display light emitted from the hologram light guide plate 22 is likely to be affected, in the spatial region A1.

The width in the X-axis direction of the hologram 221 is longer than the width in the Y-axis direction of the hologram 221. Therefore, in the spatial region A2, propagation in the X-axis direction is more likely to be affected by strain at the position of the hologram 221 than propagation in the Y-axis direction. In this regard, in this modification, the strain sensors 222 and 233 are placed along the long side direction of the hologram 221, and thus can accurately detect strain of the hologram light guide plate 22 in the direction (X-axis direction) in which deformation of the display light emitted from the hologram light guide plate 22 is likely to be affected, in the spatial region A2.

In Modification 2 in FIG. 8B, strain sensors may be placed on the rear side and the left side of the hologram 211, or strain sensors may be placed on the right side and the left side of the hologram 221.

In the above embodiment and modifications, the strain sensors are placed at the same positions on the upper surface and the lower surface of the hologram light guide plate 22 in a plan view, but may be placed on only either one of the upper surface and the lower surface. However, in order to accurately detect strain of the hologram light guide plate 22, the strain sensors are preferably placed on both the upper surface and the lower surface of the hologram light guide plate 22.

In the above embodiment, the display light incident from the incident region A11 is caused to propagate in the left direction and the rear direction and is emitted from the emission region A31. However, the present invention is not limited thereto, and the display light incident from the incident region A11 may be caused to propagate only in one direction and may be emitted from the emission region at the position of the hologram located at the propagation destination.

In the above embodiment, the incident region A11 is provided at the lower surface of the light guide path 201, and the emission region A31 is provided at the upper surface of the light guide path 201. However, the incident region A11 and the emission region A31 may be provided at either the upper surface or the lower surface of the light guide path 201.

In the above embodiment, the spatial light modulator 108 reflects the light emitted from the light source 101, to generate the display light L, but may allow the light emitted from the light source 101 to pass therethrough to generate the display light L.

In the above embodiment, the example in which the present invention is applied to the head-up display mounted on the passenger car 1 has been described, but the present invention can also be applied to other types of image display devices in addition to the vehicle-mounted device.

The configurations of the image display device 20 and the image generation part 21 are not limited to the configurations shown in FIG. 1C and FIG. 2, and can be changed as appropriate.

Various modifications can be made as appropriate to the embodiment of the present invention, without departing from the scope of the technological idea defined by the claims.

What is claimed is:

1. An image display device comprising:
an image generation part configured to generate display light having a predetermined contour shape on the basis of an image signal;
a hologram light guide plate having a light guide path in which the display light taken from an incident region propagates to an emission region, and a hologram configured to apply a diffraction action to the display light in the light guide path;
a strain sensor configured to detect strain of the hologram light guide plate; and
a controller configured to control the image generation part, wherein
the controller sets the display light generated by the image generation part, on the basis of a detection result of the strain sensor such that deformation of a display image due to strain of the hologram light guide plate is suppressed.

2. The image display device according to claim 1, wherein the strain sensor is placed in a vicinity of a placement region of the hologram along a propagation direction of the display light.

3. The image display device according to claim 1, wherein the strain sensors are placed at the same position on an upper surface and a lower surface of the hologram light guide plate, respectively, in a plan view.

4. The image display device according to claim 1, wherein the strain sensors are placed along adjacent two sides of the placement region of the hologram.

5. The image display device according to claim 1, wherein the controller controls the image generation part on the basis of the detection result of the strain sensor such that luminance unevenness of the display image due to strain of the hologram light guide plate is suppressed.

6. The image display device according to claim 1, wherein the holograms are placed at the incident region and the emission region, respectively.

7. The image display device according to claim 6, wherein the strain sensor is located near the emission region.
